(19) United States
(12) Patent Application Publication
(10) Pub. No.: US 2014/0356837 A1
(43) Pub. Date: Dec. 4, 2014

(54) SYSTEM AND METHOD FOR GENERATING AN INTERACTIVE LEARNING MAP ON LEARNING MANAGEMENT PLATFORM

(71) Applicant: LoudCloud Systems Inc., Dallas, TX (US)

(72) Inventors: Manoj Kutty, Dallas, TX (US); Harish Samgod Joshy, Navi Mumbai (IN); Chandra Shekhar Ghildiyal, Dehra Dun (IN); Anil Rajagopalan, Newark, DE (US); Bhavesh R. Bhanushali, Mumbai (IN)

(73) Assignee: LoudCloud Systems Inc., Dallas, TX (US)

(21) Appl. No.: 13/905,477

(22) Filed: May 30, 2013

(51) Int. Cl. G09B 7/08

(52) U.S. Cl. CPC G09B 7/08
USPC 434/322

(57) ABSTRACT

Disclosed is a system and method for enabling a student to achieve a proficiency level in a first learning grade on a learning management platform. A learning map generator is configured to generate an interactive learning map comprising a plurality of nodes on the learning management platform. The learning map generator is configured to form a layer comprising a first content object and a first assessment object on a first node of the plurality of nodes. Further, the learning map generator is configured to selectively embed on the first layer a plurality of content objects and a plurality of assessment objects from a Data Store using a recommendation engine. A visualization engine is configured to display the interactive learning map to the student and an instructor. The instructor evaluates the performance of the student accessing and attempting the plurality of content objects and the plurality of assessment objects respectively on the interactive learning map.

### TECHNICAL FIELD

The present subject matter described herein, in general relates to learning management systems, and more particularly to a method and system for generating an interactive learning map on learning management platforms.

### BACKGROUND

Learning Management Systems (LMS) have evolved and gained immense popularity in the last few years. The Learning Management Systems (LMS) have facilitated digital education for students, instructors and course-seekers using computer as a medium. With the widespread availability of the Internet, the Learning Management Systems (LMS) have been made available across the globe in form of e-learning systems, and in fact, use of such systems is one of the fastest growing applications of information and communication technology. Many institutions, including but not limited to colleges, universities and even corporate establishments are instituting e-learning systems as an effective means to dissipate knowledge.

The Learning Management Systems (LMS) may allow students to read course materials, textbooks and other learning materials on their electronic devices such as but not limited to mobile phones, tablets, laptops, and computers etc. However, such textbooks, course materials and other course contents may not enable the students to be proficient or advanced in a specific class or a subject. This may be due to limited set of course content available on the Learning Management Systems (LMS). Further, these course contents and the learning materials may be of same type, identical complexity and similar nature. Therefore, though few of the students may be able to get acquainted with the subject of the class by referring these course contents and the learning materials, the other students may find difficult to get familiar with the subject. This is because the capability of each student to grasp the subject of a particular grade may be different. This may impact the student's capability and proficiency in understanding the subject of the particular grade, which may further result in adverse effect on the student's overall growth and progress in the educational field.

### SUMMARY

This summary is provided to introduce concepts related to systems and methods for enabling a student to achieve a proficiency level in a first learning grade on a learning management platform and the concepts are further elaborated below in the detailed description. This summary is not intended to identify all essential features of the claimed subject matter nor is it intended for use in determining or limiting the scope of the claimed subject matter.

In one implementation, a system for enabling a student to achieve a proficiency level in a first learning grade on a learning management platform embodied thereon is disclosed. The system comprises a processor and a memory coupled to the processor for executing a plurality of modules present in the memory. The plurality of modules comprises a learning map generator, a visualization engine, a recommendation engine, an E-Reader module, and a Data Store. The learning map generator is configured to generate an interactive learning map comprising a plurality of nodes on the learning management platform. The plurality of the nodes enables tracking of performance of the student in a plurality of learning grades. The learning map generator is configured to form a layer comprising a first content object and a first assessment object on a first node of the plurality of nodes. The first node enables tracking the performance of the student in the first learning grade. The learning map generator is configured to selectively embed on the first layer a second content object, a second assessment object, a third content object, a third assessment object, a fourth content object and a fourth assessment object. The visualization engine is configured to display the interactive learning map comprising the plurality of nodes including the said first node to the student and an instructor. Further, the visualization engine is configured to enable the student to achieve the proficiency level in the first learning grade. The visualization engine facilitates the student to access the first content object and attempt the first assessment object thereafter. Additionally, the visualization engine facilitates the student to selectively access the second content object, the third content object and the fourth content object and thereafter attempt the second assessment object, the third assessment object, and the fourth assessment object, respectively. The performance of the student attempting the first assessment object, the second assessment object, the third assessment object, and the fourth assessment object is evaluated by the instructor. The recommendation engine is configured to query the Data Store to obtain at least one of the second content object, the third content object, the fourth content object, the second assessment object, the third assessment object and the fourth assessment object.

In another implementation, a method for enabling a student to achieve a proficiency level in a first learning grade on a learning management platform is disclosed. The method comprises a plurality of steps performed by a processor. The method comprises a step of generating an interactive learning map comprising a plurality of nodes on the learning management platform. The plurality of the nodes enables tracking of performance of the student in a plurality of learning grades. The method further comprises a step of forming a layer comprising a first content object and a first assessment object on a first node of the plurality of nodes. The first node enables tracking the performance of the student in the first learning grade. The method further comprises a step of selectively embedding on the layer a second content object, a second assessment object, a third content object, a third assessment object, a fourth content object and a fourth assessment object by querying a Data Store. Further, the method comprises a step of enabling the student to achieve the proficiency level in the first learning grade by facilitating the student to access the first content object and attempt the first assessment object thereafter. The method further comprises a step of selectively accessing the second content object, the third content object, and the fourth content object and thereafter attempting the second assessment object, the third assessment object, and the fourth assessment object respectively. The performance of the student attempting the first assessment object and selectively, the second assessment object, the third assessment object and the fourth assessment object is evaluated by an instructor on the learning management platform.

In another implementation, a non-transitory computer program product, having embodied thereon computer-executable instructions for enabling a student to achieve a proficiency level in a first learning grade on a learning management platform, is disclosed. The computer-executable instructions include instructions for generating an interactive learning map comprising a plurality of nodes on the learning management platform. The plurality of the nodes enables tracking of performance of the student in a plurality of learning grades. The computer program product comprises a program code for forming a layer comprising a first content object and a first assessment object on a first node of the plurality of nodes. The first node enables tracking the performance of the student in the first learning grade. The computer program product comprises a program code for selectively embedding on the layer a second content object, a second assessment object, a third content object, a third assessment object, a fourth content object and a fourth assessment object by querying a Data Store. Further, the computer program product comprises a program code for enabling the student to achieve the proficiency level in the first learning grade by facilitating the student to access the first content object and attempt the first assessment object thereafter. The computer program product comprises a program code for selectively accessing the second content object, the third content object and the fourth content object and thereafter attempting the second assessment object, the third assessment object, and the fourth assessment object respectively. The performance of the student attempting the first assessment object and selectively, the second assessment object, the third assessment object and the fourth assessment object is evaluated by an instructor on the learning management platform.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to refer to like features and components.

FIG. 1 illustrates a network implementation of a system for enabling a student to achieve a proficiency level in a first learning grade on a learning management platform, in accordance with an embodiment of the present subject matter.

FIG. 2 illustrates the system, in accordance with an embodiment of the present subject matter.

FIG. 3 illustrates a method for enabling a student to achieve a proficiency level in a first learning grade on a learning management platform, in accordance with an embodiment of the present subject matter.

FIG. 4 illustrates the method, in accordance with an embodiment of the present subject matter.

### DETAILED DESCRIPTION

Systems and methods for enabling a student to achieve a proficiency level in a first learning grade on a learning management platform are now described in detail. An interactive learning map comprising a plurality of nodes on the learning management platform may be generated. The plurality of the nodes may enable tracking of performance of the student in a plurality of learning grades (e.g., “beginner,” “intermediate,” “advanced,” “1st grade,” “2nd grade,” etc.). The tracking of the performance of the student is enabled by visually representing the plurality of nodes in distinct patterns. Each of the distinct patterns is indicative of whether the student has achieved the proficiency level (e.g., a percentile or percentage value (“65%”), a letter grade (“B+”), a score (“175/200”), etc.) in the plurality of learning grades. The student is navigated from one node to other on the interactive learning map when the said student achieves the proficiency level in the said node. For example, the interactive learning map may include depictions of travel maps, animations (e.g., space travel), game simulations (e.g., racing simulations), etc., and nodes on such maps may include depictions of geopolitical destinations (e.g., states, cities, etc.), travel destinations (e.g., courthouse, museum, etc.), etc. It is to be understood that the above examples are purely illustrative and not limiting. In general, this disclosure contemplates any visual or audiovisual depiction of maps and nodes.

Subsequent to generation of the interactive learning map, a layer comprising a first content object and a first assessment object on a first node of the plurality of nodes may be formed. In some embodiments, a layer may include graphics objects (e.g., images, sound files, interactive audiovisual media, etc.), textual information, or the like. A layer may include sub-layers, each including its own objects. In some embodiments, layers may include metadata, e.g., providing references or links (e.g., URLs or file paths) to content objects or assessment objects stored in a Data Store. The first content object may be associated with a standard textbook of the first learning grade. In some embodiments, all materials needed for participation in the first learning grade may be available in the first content object. Further, the first assessment object may be related to the first content object. For example, the assessment object may collect: user information (e.g., user ID, user name, student ID, institution ID, institution name, etc.); statistics information (e.g., length of time to reach a chapter within the first content object, problem-solving accuracy/time, number of jumps taken through material in the first content object, path taken to navigate through the first content object, (total) pause time within the first content object, amount or frequency of interaction with the first content object, etc.); grading information (a percentile or percentage value, a letter grade, a score, etc.); or the like. The first node may enable tracking the performance of the student in the first learning grade. A second content object and a second assessment object may be optionally embedded on the layer by querying a Data Store. The second content object and the second assessment object may be optionally embedded based on the performance of the student in the first assessment object. Further, a third content object and a third assessment object may be optionally embedded on the layer by querying the Data Store. The third content object and the third assessment object may be optionally embedded based on the performance of the student in the second assessment object. Additionally, a fourth content object and a fourth assessment object may be optionally embedded on the layer by querying the Data Store. The fourth content object and the fourth assessment object may be optionally embedded based on the performance of the student in the third assessment object. The layer formed on the interactive learning map may enable to constitute a learning path followed by the student. Further, the learning path may be utilized for enabling at least one other student to achieve the proficiency level in the first learning grade. For example, a plurality of students, or users, may be able to use the interactive learning map simultaneously.

The Data Store may comprise a plurality of content objects and a plurality of assessment objects. For example, the Data Store may be implemented as a relational database management system (RDBMS), and may be interacted with using commands in, e.g., structured query language (SQL). As another example, the Data Store may be implemented using a computer file system, with directories, folders, files, etc. The plurality of content objects may include at least one of the second content object, the third content object, and the fourth content object. The plurality of assessment objects may include at least one of the second assessment object, the third assessment object and the fourth assessment object. The second content object, the second assessment object, the third content object, the third assessment object, the fourth content object and the fourth assessment object may be aligned to standards prescribed by the statutory authorities for the first learning grade. In one example, the plurality of content objects and the plurality of assessment objects may comprise at least one of: spreadsheets, word processing files, multimedia files, PDF files, XML-encoded files, JSON-encoded files, HTML files, or the like. In general, this disclosure contemplates that the content objects and assessment objects may be implemented in any information storage format. The plurality of content objects and the plurality of assessment objects may be retrieved from at least one of a content repository, a search engine and an E-Reader module. For example, the content may be stored in, e.g., local memory of the computer system implementing the learning management platform, (portable) detachable storage (such as a USB memory), on a computer operatively connected to a computer network, on the Internet, etc. The Data Store may be queried, e.g., using SQL commands, using at least one tag identifier to embed the at least one of the second content object, the second assessment object, the third content object, the third assessment object, the fourth content object and the fourth assessment object. The tag identifiers may include, without limitation: user ID, learning map IP, institution ID, learning grade, grade score, timestamp of last-stored state of the interactive learning map, etc. In general, any information collected or stored by the learning management platform may serve as a tag identifier. The first content object, the first assessment object, the second content object, the second assessment object, the third content object, the third assessment object, the fourth content object and the fourth assessment object may be distinctly represented in a unique visual format on the layer of the interactive learning map. In one example, the unique visual format may be at least one of an icon, an image, an animated image, and a hyperlink.

Subsequent to the embedding at least one of the plurality of content objects and at least one of the plurality of assessment objects, the student may be enabled to achieve the proficiency level in the first learning grade. To enable this, the student may be facilitated to access the first content object and attempt the first assessment object thereafter. The student may, for example, be able to interact with the interactive learning map, content objects, and/or assessment objects through touch input, keyboard commands, mouse commands, voice commands, etc. Further, the student may be enabled to optionally access the second content object, the third content object and the fourth content object and thereafter attempt the second assessment object, the third assessment object and the fourth assessment object respectively. The performance of the student attempting the first assessment object and optionally, the second assessment object, the third assessment object and the fourth assessment object may be evaluated by an instructor on the learning management platform. For example, the instructor may be able to access the assessment object, obtain data from the assessment object, view actual student performance related to the assessment object (e.g., in real-time), and store evaluations of the student into the assessment object. Thus, in some embodiments, the assessment may be capable of storing all information related to the student's performance and instructor evaluation. In some embodiments, the instructor may be able to view and/or modify the assessment object in real-time, e.g., from a separate computing terminal, simultaneous with the student's performance or operations related to the assessment object. In some embodiments, the assessment object may be provided with access privilege mechanisms so that different users (e.g., students, instructors, administrators, etc.) may have different access privileges at different times to the assessment objects. For example, the assessment object may be subject to data encryption mechanisms (e.g., RSA, AES, etc.), requiring one or more encryption keys to access different portions of the assessment object. In some embodiments, the access privileges associated with the content and assessment objects may depend on student performance, completion of instructor evaluations, or the like. Thus, in some embodiments, the second content object, the third content object and the fourth content object may be embedded and/or accessed by the student only when it is determined that the student has failed to achieve the proficiency level based on the performance of the student in the first assessment object, the second assessment object and the third assessment object respectively.

While aspects of described system and method for enabling a student to achieve a proficiency level in a first learning grade on a learning management platform may be implemented in any number of different computing systems, environments, and/or configurations, the embodiments herein are described in the context of the following exemplary system.

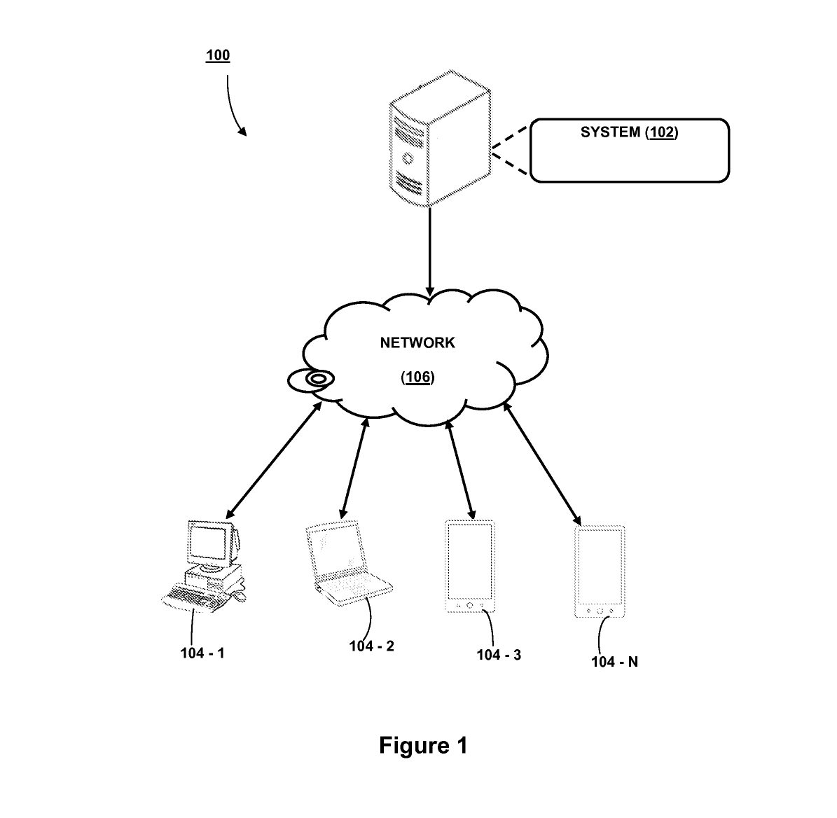

Referring now to FIG. 1, a network implementation 100 of a system 102 for enabling a student to achieve a proficiency level in a first learning grade on a learning management platform is illustrated, in accordance with an embodiment of the present subject matter. In one embodiment, the system 102 may generate an interactive learning map comprising a plurality of nodes on the learning management platform. The plurality of the nodes may enable tracking of performance of the student in a plurality of learning grades. The system 102 may form a layer comprising a first content object and a first assessment object on a first node of the plurality of nodes. The first node may enable tracking the performance of the student in the first learning grade. The system 102 may optionally embed on the layer a second content object and a second assessment object based on the performance of the student in the first assessment object. The system 102 may optionally embed on the layer a third content object and a third assessment object based on the performance of the student in the second assessment object. The system 102 may optionally embed on the layer a fourth content object and a fourth assessment object based on the performance of the student in the third assessment object. The system 102 may optionally embed on the layer the second content object, the second assessment object, the third content object, the third assessment object, the fourth content object and the fourth assessment object by querying a Data Store. Further, the system 102 may enable the student to achieve the proficiency level in the first learning grade. To enable this, the system 102 may facilitate the student to access the first content object and attempt the first assessment object thereafter. The system 102 may further facilitate the student to optionally access the second content object, the third content object and the fourth content object and thereafter attempt the second assessment object, the third assessment object and the fourth assessment object respectively. The performance of the student attempting the first assessment object and optionally, the second assessment object, the third assessment object and the fourth assessment object may be evaluated by an instructor on the learning management platform.

Although the present subject matter is explained considering that the system 102 may be implemented as a learning management system on a server, it may be understood that the system 102 may also be implemented in a variety of computing systems, such as a laptop computer, a desktop computer, a notebook, a workstation, a mainframe computer, a server, a network server, and the like. It may be understood that the system 102 may be accessed by multiple users through one or more user devices 104-1, 104-2 . . . 104-N, collectively referred to as user 104 hereinafter, or applications residing on the user devices 104. Examples of the user devices 104 may include, but may not be limited to, a portable computer, a personal digital assistant, a handheld device, and a workstation. The user devices 104 may be communicatively coupled to the system 102 through a network 106. Further, the user 104 may be at least one of the student and the instructor collaborating over the network 106 for facilitating online education.

In one embodiment, the network 106 may be a wireless network, a wired network or a combination thereof. The network 106 can be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

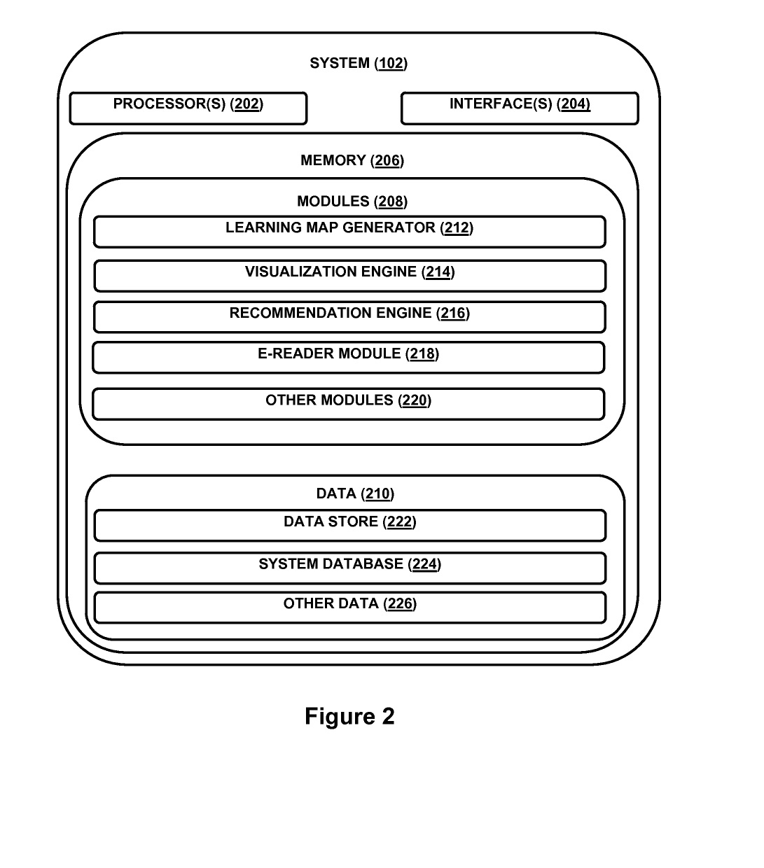

Referring now to FIG. 2, the system 102 is illustrated in accordance with an embodiment of the present subject matter. In one embodiment, the system 102 may include at least one processor 202, an input/output (I/O) interface 204, and a memory 206. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 is configured to fetch and execute computer-readable instructions stored in the memory 206.

The I/O interface 204 may include a variety of software and hardware interfaces, for example, a web interface, a graphical user interface, and the like. The I/O interface 204 may allow the system 102 to interact with the user directly or through the user devices 104. In one embodiment, the I/O interface 204 may include the learning management platform that allows the student and the instructor to interact with the system 102. Further, the I/O interface 204 may enable the system 102 to communicate with other computing devices, such as web servers and external data servers (not shown). The I/O interface 204 may facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium or computer program product known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 206 may include modules 208 and data 210.

The modules 208 include routines, programs, objects, components, data structures, etc., which perform particular tasks or implement particular abstract data types. In one implementation, the modules 208 may include a learning map generator 212, a visualization engine 214, a recommendation engine 216, an E-Reader module 218, and other modules 220. The other modules 220 may include programs or coded instructions that supplement applications and functions of the system 102.

The data 210, amongst other things, serves as a repository for storing data processed, received, and generated by one or more of the modules 208. The data 210 may also include a Data Store 222, a system database 224 and other data 226. The other data 226 may include data generated as a result of the execution of one or more modules in the other modules 220.

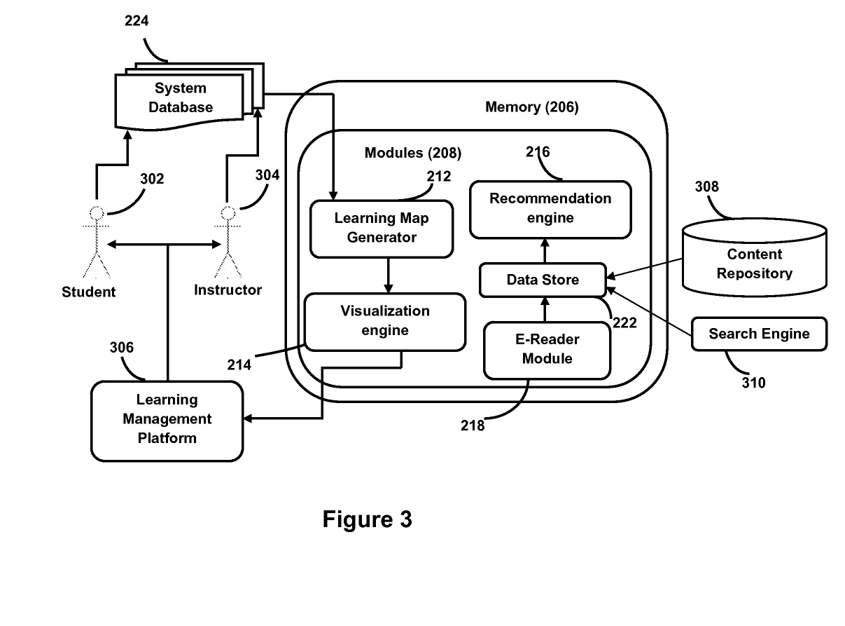

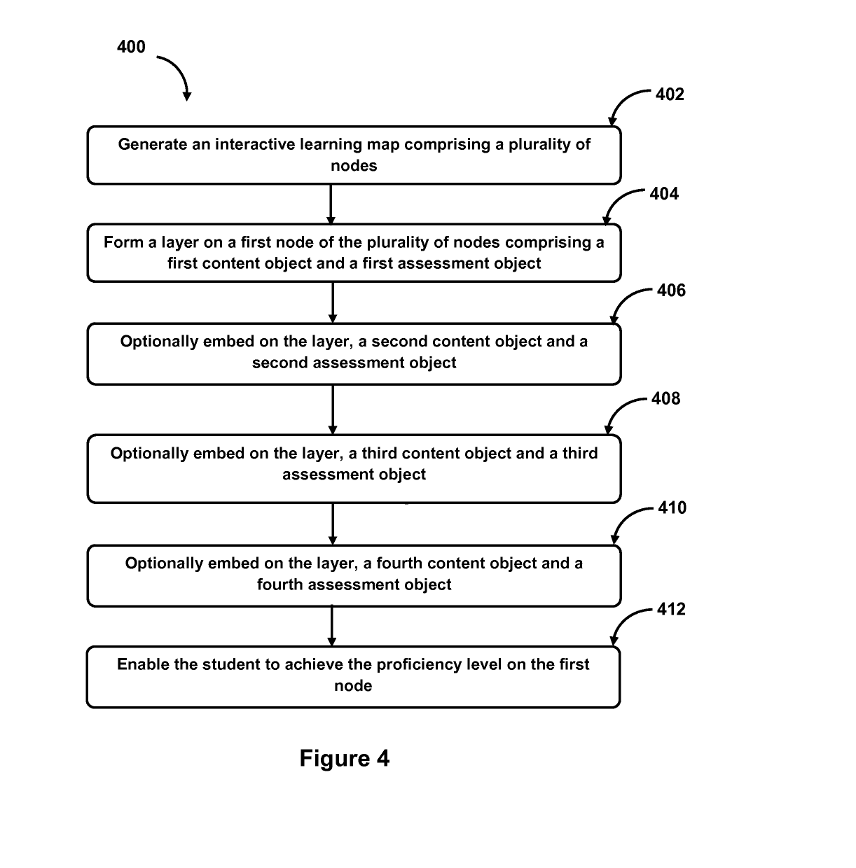

In one embodiment, at first, a user may use at least one of the user devices 104 to access the system 102 via the I/O interface 204. The user may register using the I/O interface 204 in order to use the system 102. The working of the system 102 may be explained in detail in FIGS. 3 and 4 explained below. The system 102 may be used for enabling a student to achieve a proficiency level in a first learning grade on a learning management platform.

Referring to FIG. 3, a detailed working of the components of the system 102 is illustrated, in accordance with an embodiment of the present subject matter. In one implementation, the student 302 and the instructor 304 may register on the system 102 via a learning management platform 306. The student 302 and the instructor 304 may be authenticated on the learning management platform 306 by means of an authentication and authorization module (not shown in the figure). Once authenticated, both the student 302 and the instructor 304 are authorized to use the system 102 and the components of the system 102.

The student 302 may access an interactive learning map generated by the learning map generator 212 via the learning management platform 306. The learning map generator 212 may be configured to generate the interactive learning map in a visualized manner. The interactive map may comprise a plurality of nodes. The plurality of nodes enables tracking of the performance of the student 302 in a plurality of learning grades. The instructor 304 may be enabled to evaluate the performance of the student 302 in the plurality of learning grades. The instructor 302 may assign grades to the student 302 using a grade book module (not shown in the figure). Further, the instructor 304 may be enabled to set a benchmark value that is indicative of the proficiency level for the plurality of learning grades. The tracking of the performance of the student is enabled by visually representing the plurality of nodes in distinct patterns. Each of the distinct patterns may be indicative of whether the student has achieved the proficiency level in the plurality of learning grades.

Specifically, the tracking of the performance of the student may be enabled by visually representing the plurality of nodes with distinct colors comprising red, yellow and green. At least one of the nodes visually represented with the red, the yellow and the green colors may indicate that the performance of the student 302 may be “satisfactory”, “partially proficient” and “proficient” respectively. The grades assigned by the instructor 304 may be analyzed to compare with the benchmark value stored in the system database 224. Depending on the comparison, it may be determined whether the student 302 has achieved the proficiency level in the plurality of learning grades. When the performance of the student 302 may be indicated as “partially proficient” and “proficient”, then it may be determined that the student has achieved the proficiency level. On the contrary, when the performance of the student 302 is indicated as “satisfactory”, then it may be determined that the student 302 has failed to achieve the proficiency level. In one embodiment, the at least of the nodes being indicated with the green color may determine that the student has achieved the proficiency level. That is, the at least one of the nodes indicated with the red color and the yellow color may determine that the student has failed to achieve the proficiency level. The student 302 may be navigated from one node to other on the interactive learning map when the student 302 achieves the proficiency level in the said node. The interactive learning map may be displayed to the student 302 and the instructor 304 on the learning management platform 306 through the visualization engine 214.

In one embodiment, a first node on the interactive learning map may enable tracking of the performance of the student 302 in a first learning grade. Specifically, the performance of the student in a subject of the first learning grade may be tracked. In order to enable this, the learning map generator 212 may initially form a layer on the first node comprising a first content object and a first assessment object. The first content object may be associated with a standard textbook of the subject of the first learning grade. Further, the first assessment object may be related to the first content object. The first content object and the first assessment object may be retrieved from the system database 224. The student 302 may access the first content object and attempt the first assessment object thereafter through the visualization engine 214. The instructor 304 may be enabled to evaluate the performance of the student 302 in the first node. The instructor 304 may assess the first assessment object being attempted by the student 302.

In one embodiment, the instructor 304 may assign a first grade to the student 302 using the grade book module as a result of the assessment of the first content object. The first grade may be stored in the system database 224. Further, the first grade may be compared with the benchmark value to verify whether the student 302 has achieved the proficiency level in the first learning grade. When the first node following assessment of the first assessment object is indicated with at least one of the red color and the yellow color, the recommendation engine 216 may be configured to recommend at least one content object and at least one assessment object other than the first content object and the first assessment object respectively by querying the Data Store 222.

The Data Store 222 may comprise a plurality of content objects and a plurality of assessment objects. The plurality of content objects and the plurality of content objects may be aligned to standards prescribed by the statutory authorities for the first learning grade. In one example, the plurality of content objects and the plurality of assessment objects may comprise at least one of spreadsheets, word processing files, multimedia files, PDF files, XML-encoded files, JSON-encoded files, HTML files, etc. The plurality of content objects and the plurality of assessment objects may be tagged in the Data Store. The plurality of content objects and the plurality of assessment objects may be retrieved from at least one of a content repository 308, a search engine 310 and the E-Reader module 218.

In one embodiment, the recommendation engine 216 may query the Data Store 222 to retrieve a second content object and a second assessment object using at least one tag identifier. The at least one tag identifier may identify the second content object and the second assessment object tagged in the Data Store 222. The learning map generator 212 may be configured to embed the second content object and the second assessment object on the layer of the first node. The second content object and the second assessment object may be distinctly represented in a unique visual format on the layer of the interactive learning map. In one example, the unique visual format may be at least one of an icon, an image, an animated image, and a hyperlink. The second content object and the second assessment object may be displayed to the student 302 through the visualization engine 214. The student 302 may access the second content object and thereafter attempt the second assessment object. The instructor 304 may notify the student 302 to access the second content object and thereafter attempt the second assessment object via a notification engine (not shown in the figure). The instructor 304 may evaluate the performance of the student 302 in the second assessment object. The instructor 304 may assign a second grade using the grade book module. The second grade may be stored in the system database 224. Further, the second grade may be compared with the benchmark value to verify whether the student 302 has achieved the proficiency level in the first learning grade. When the first node following assessment of the second assessment object is still indicated with at least one of the red color and the yellow color, the recommendation engine 216 may be configured to query the Data Store 222 to retrieve a third content object and a third assessment object. The third content object and the third assessment object may be embedded on the layer of the first node of the interactive learning map for further accessing and attempting by the student 302. Similarly, based on the performance of the student 302 in the third assessment object, a fourth content object and a fourth assessment object may be retrieved and embedded on the layer of the first node. The student 302 may achieve the proficiency level based on accessing at least of the first content object, the second content object, the third content object and the fourth content object. The performance of the student 302 in the at least one of the first assessment object, the assessment content object, the third assessment object and the fourth assessment object may be evaluated by the instructor 304.

In one embodiment, the layer formed on the interactive learning map comprising the first content object and at least one of the second content object, the third content object and the fourth content object may be profiled. Further, the layer formed on the interactive learning map comprising the first assessment object and at least one of the second assessment object, the third assessment object and the fourth assessment object may be profiled. Such profiling of the layer may enable to generate a learning path or a learning pattern followed by the student 302. The learning path or the learning pattern may be stored in the system database 224. The learning path may be utilized for recommending at least one content object and at least one assessment object to at least one other student whose learning capabilities are similar to the student 302. In one embodiment, a plurality of learning paths may be generated which eventually get stored in the system database 224.

In one embodiment, the instructor 304 may be enabled to generate an aggregated Learning Map for a plurality of students in a class using the learning map generator 212. When any of the plurality of students in a node of the aggregated Learning Map is indicated with the yellow color, and all other students are indicated with the green color, the said node may be indicated with the yellow color at class aggregation level. Similarly, when any of the plurality of students in the said node of the aggregated Learning Map is indicated with the red color, and few of the students are indicated with the yellow color, and the other students are indicated with the green color, the said node may be indicated with the red color at the class aggregation level. In one embodiment, the instructor 304 may be enabled to click on the said node to view which student has been indicated by which color. If the said node is indicated with the red color and the said node also has a student indicated with the yellow color, then both the student indicated with the red color and the yellow color may be displayed. The instructor 304 may be enabled to view a learning map of an individual student aggregated Learning Map.

Referring now to FIG. 4, a method 400 for enabling a student to achieve a proficiency level in a first learning grade on a learning management platform of the system 102 is illustrated in accordance with an embodiment of the present subject matter. The method 400 may be described in the general context of computer executable instructions. Generally, computer executable instructions can include routines, programs, objects, components, data structures, procedures, modules, functions, etc., that perform particular functions or implement particular abstract data types. The method 400 may also be practiced in a distributed computing environment where functions are performed by remote processing devices that are linked through a communications network. In a distributed computing environment, computer executable instructions may be located in both local and remote computer storage media, including memory storage devices.

The order in which the method 400 is described is not intended to be construed as a limitation, and any number of the described method blocks can be combined in any order to implement the method 400 or alternate methods. Additionally, individual blocks may be deleted from the method 400 without departing from the spirit and scope of the subject matter described herein. Furthermore, the method can be implemented in any suitable hardware, software, firmware, or combination thereof. However, for ease of explanation, in the embodiments described below, the method 400 may be considered to be implemented in the above described system 102.

At block 402, an interactive learning map comprising a plurality of nodes may be generated on the learning management platform. The plurality of nodes generated may enable the tracking of performance of the student on the plurality of nodes, wherein each of the plurality of nodes indicates a learning grade. In one embodiment, the interactive learning map may be generated by the learning map generator 212. In one embodiment, the interactive learning map may be displayed to the student and the instructor by the visualization engine 214

At block 404, a layer may be formed on a first node of the plurality of nodes. The first node may indicate the performance of the student in a first learning grade. The layer may comprise a first content object and a first assessment object. In one embodiment, the layer may be formed by the learning map generator 212. In one embodiment, the layer formed may be displayed on the interactive learning map by the visualization engine 214. The student may access the first content object and attempt the first assessment object thereafter. The instructor may evaluate the first assessment object being attempted by the student.

At block 406, optionally, a second content object and a second assessment object may be embedded on the layer of the first node. In one embodiment, the second content object and the second assessment object may be embedded by the learning map generator 212. The second content object and the second assessment object may be retrieved by querying the Data Store 222 using the recommendation engine 216. The second content object and the second assessment object may be optionally embedded based on the performance of the student in the first assessment object being evaluated by the instructor. In one embodiment, the second content object and the second assessment may be displayed on the interactive learning map by the visualization engine 214. The student may access the second content object and attempt the second assessment object thereafter. The instructor may evaluate the second assessment object being attempted by the student.

At block 408, a third content object and a third assessment object may be embedded on the layer of the first node. In one embodiment, the third content object and the third assessment object may be embedded by the learning map generator 212. The third content object and the third assessment object may be retrieved by querying the Data Store 222 using the recommendation engine 216. The third content object and the third assessment object may be optionally embedded based on the performance of the student in the second assessment object being evaluated by the instructor. In one embodiment, the third content object and the third assessment may be displayed on the interactive learning map by the visualization engine 214. The student may access the third content object and attempt the third assessment object thereafter. The instructor may evaluate the third assessment object being attempted by the student.

At block 410, a fourth content object and a fourth assessment object may be embedded on the layer of the first node. In one embodiment, the fourth content object and the fourth assessment object may be embedded by the learning map generator 212. The fourth content object and the fourth assessment object may be retrieved by querying the Data Store 222 using the recommendation engine 216. The fourth content object and the fourth assessment object may be optionally embedded based on the performance of the student in the third assessment object being evaluated by the instructor. In one embodiment, the fourth content object and the fourth assessment may be displayed on the interactive learning map by the visualization engine 214. The student may access the fourth content object and attempt the fourth assessment object thereafter. The instructor may evaluate the fourth assessment object being attempted by the student.

At block 412, the student may be enabled to achieve the proficiency level in the first learning grade by accessing the first content object and the first assessment object thereafter. Further, the student may optionally access the second content object, the third content object, the fourth content object and thereafter attempt the second assessment object, the third assessment object and the fourth assessment object respectively to achieve the proficiency level in the first learning grade.

Although implementations for methods and systems for enabling a student to achieve a proficiency level in a first learning grade on a learning management platform have been described in language specific to structural features and/or methods, it is to be understood that the appended claims are not necessarily limited to the specific features or methods described. Rather, the specific features and methods are disclosed as examples of implementations for enabling a student to achieve a proficiency level in a first learning grade on a learning management platform.

I/We claim:

1. A processor-implemented learning management method, comprising:
generating, by a processor, an interactive learning map comprising a plurality of nodes on a learning management platform, wherein the plurality of the nodes enables tracking of performance of a student in a plurality of learning grades;
forming, by the processor, a layer comprising a first content object and a first assessment object on a first node of the plurality of nodes, wherein the first node enables tracking the performance of the student in a first learning grade;
selectively embedding, by the processor, on the layer:
a second content object and a second assessment object by querying a Data Store, wherein the second content object and the second assessment object is selectively embedded based on the performance of the student in the first assessment object,
a third content object and a third assessment object by querying the Data Store, wherein the third content object and the third assessment object is selectively embedded based on the performance of the student in the second assessment object, and
a fourth content object and a fourth assessment object by querying the Data Store, wherein the fourth content object and the fourth assessment object is selectively embedded based on the performance of the student in the third assessment object; and
enabling, by the processor, the student to achieve a proficiency level in the first learning grade by facilitating the student to:
access the first content object and attempt the first assessment object thereafter, and
selectively, access the second content object, the third content object and the fourth content object and thereafter attempt the second assessment object, the third assessment object and the fourth assessment object respectively, wherein the performance of the student attempting the first assessment object and selectively, the second assessment object, the third assessment object and the fourth assessment object is evaluated by an instructor on the learning management platform.

2. The method of claim 1, wherein the student is navigated from the first node to a subsequent node on the interactive learning map, when the student achieves the proficiency level in the first node.

3. The method of claim 1, wherein the first content object is associated with a standard textbook of the first learning grade, and wherein the first assessment object is related to the first content object.

4. The method of claim 1, wherein the Data Store comprises a plurality of content objects and a plurality of assessment objects including at least one of the second content object, the second assessment object, the third content object, the third assessment object, the fourth content object and the fourth assessment object.

5. The method of claim 4, wherein the second content object, the second assessment object, the third content object, the third assessment object, the fourth content object and the fourth assessment object are aligned to standards prescribed by the statutory authorities for the first learning grade.

6. The method of claim 4, wherein the plurality of content objects and the plurality of assessment objects comprises at least one of spread sheets, word processing files, multimedia files and HTML files, and wherein the plurality of content objects and the plurality of assessment objects are retrieved from at least one of a content repository, a search engine and an E-Reader module.

7. The method of claim 1, wherein the first content object, the first assessment object, the second content object, the second assessment object, the third content object, the third assessment object, the fourth content object and the fourth assessment object is distinctly represented in a unique visual format on the layer of the interactive learning map, and wherein the unique visual format comprises at least one of an icon, an image, an animated image, and a hyperlink.

8. The method of claim 1, wherein the Data Store is queried using at least one tag identifier to embed at least one of the second content object, the second assessment object, the third content object, the third assessment object, the fourth content object and the fourth assessment object.

9. The method of claim 1, wherein the second content object, the third content object and the fourth content object is embedded only when it is determined that the student has failed to achieve the proficiency level based on the performance of the student in the first assessment object, the second assessment object and the third assessment object respectively being evaluated by the instructor.

10. The method of claim 1, wherein the layer formed on the interactive learning map enables to constitute a learning path followed by the student, and wherein the learning path is utilized for enabling at least one other student to achieve the proficiency level in the first learning grade.

11. The method of claim 1, wherein the tracking of the performance of the student is enabled by visually representing the plurality of nodes in distinct patterns, wherein each of the distinct patterns is indicative of whether the student has achieved the proficiency level in the plurality of learning grades.

12. A learning management system, comprising:
a processor; and
a memory coupled to the processor, and storing a plurality of processor-executable modules, the plurality of modules comprising:
a learning map generator, configured to:
generate an interactive learning map comprising a plurality of nodes on a learning management platform, wherein the plurality of the nodes enables tracking of performance of a student in a plurality of learning grades,
form a layer comprising a first content object and a first assessment object on a first node of the plurality of nodes, wherein the first node enables tracking the performance of the student in a first learning grade, and
selectively embed, on the first layer:
a second content object and a second assessment object, wherein the second content object and the second assessment object is selectively embedded based on the performance of the student in the first assessment object,
a third content object and a third assessment object, wherein the third content object and the third assessment object is selectively embedded based on the performance of the student in the second assessment object, and
a fourth content object and a fourth assessment object, wherein the fourth content object and the fourth assessment object is selectively embedded based on the performance of the student in the third assessment object;
a visualization engine, configured to:
display the interactive learning map comprising the plurality of nodes including the said first node to the student and an instructor, and
enable the student to achieve a proficiency level in the first learning grade by facilitating the student to:
access the first content object and attempt the first assessment object thereafter, and
selectively, access the second content object, the third content object and the fourth content object and thereafter attempt the second assessment object, the third assessment object and the fourth assessment object respectively, wherein the performance of the student attempting the first assessment object, the second assessment object, the third assessment object and the fourth assessment object is evaluated by the instructor; and
a recommendation engine, configured to query a Data Store to obtain at least one of the second content object, the third content object, the fourth content object, the second assessment object, the third assessment object and the fourth assessment object.

13. The system of claim 12, wherein the Data Store comprises a plurality of content objects and a plurality of assessment objects, and wherein the plurality of content objects includes the at least one of the second content object, the second assessment object, the third content object, the third assessment object, the fourth content object and the fourth assessment object.

14. The system of claim 13, wherein the plurality of content objects and the plurality of assessment objects are retrieved from at least one of a content repository, a search engine and an E-Reader module.

15. The system of claim 12, wherein the first content object, the first assessment object, the second content object, the second assessment object, the third content object, the third assessment object, the fourth content object and the fourth assessment object is distinctly represented in a unique visual format on the layer of the interactive learning map, and wherein the unique visual format comprises at least one of an icon, an image, an animated image, and a hyperlink.

16. The system of claim 12, wherein the visualization engine is configured to enable the tracking of the performance of the student by visually representing the plurality of nodes in distinct patterns, wherein each of the distinct patterns is indicative of whether the student has achieved the proficiency level in the plurality of learning grades.

17. A non-transitory computer program product having embodied thereon computer-executable learning management instructions, the instructions comprising instructions for:
generating an interactive learning map comprising a plurality of nodes on a learning management platform, wherein the plurality of the nodes enables tracking of performance of a student in a plurality of learning grades;
forming a layer comprising a first content object and a first assessment object on a first node of the plurality of nodes, wherein the first node enables tracking the performance of the student in a first learning grade;
selectively embedding on the layer:
a second content object and a second assessment object by querying a Data Store, wherein the second content object and the second assessment object is selectively embedded based on the performance of the student in the first assessment object,
a third content object and a third assessment object by querying the data store, wherein the third content object and the third assessment object is selectively embedded based on the performance of the student in the second assessment object, and
a fourth content object and a fourth assessment object by querying the Data Store, wherein the fourth content object and the fourth assessment object is selectively embedded based on the performance of the student in the third assessment object; and
enabling the student to achieve a proficiency level in the first learning grade by facilitating the student to:
access the first content object and attempt the first assessment object thereafter, and
selectively, access the second content object, the third content object and the fourth content object and thereafter attempt the second assessment object, the third assessment object and the fourth assessment object respectively, wherein the performance of the student attempting the first assessment object and selectively, the second assessment object, the third assessment object and the fourth assessment object is evaluated by an instructor on the learning management platform.
